(19) United States
(12) Patent Application Publication
(10) Pub. No.: US 2004/0057433 A1
(43) Pub. Date: Mar. 25, 2004

(54) Methods and systems for prioritizing packets of data in a communications system

(76) Inventors: Wayne T. Daniel, Garland, TX (US); Akkamapet P. Sundarraj, Cupertino, CA (US); Robert D. Kehn, The Colony, TX (US); Roy E. Rowan, Terrell, TX (US); Thomas R. Miller, Plano, TX (US)

Correspondence Address: Siemens Corporation, Intellectual Property Department, 186 Wood Avenue South, Iselin, NJ, 08830, US

(21) Appl. No.: 10/253,969

(22) Filed: Sep. 24, 2002

(51) Int. Cl. H04L 12/56

(52) U.S. Cl. 370/392; 709/240

(57) ABSTRACT

Methods and systems disclosed facilitate the prioritization and transmission of packets of data by overriding Quality of Service (QoS) bits in the packets based on predefined criteria. In one embodiment, a method includes the steps of receiving a packet from an application (111, 112, 113) in a data processing system (100) by a marker (305); examining the packet for predefined criteria; overriding the value of QoS bits in the packet based on the predefined criteria; and forwarding the packet for further transmission in a communications system (300) based on the value of the QoS bits.

### CROSS-REFERENCE TO RELATED U.S. APPLICATION

This application is related to co-pending application Ser. No. ______ (Attny Docket No. 2002P15774US) entitled “Methods and Systems for Providing Differentiated Quality of Service in a Communications System,” filed on the same date herewith and incorporated by reference herein in its entirety.

### FIELD OF THE INVENTION

The present invention relates to communications systems, and more particularly to methods and systems for providing differentiated quality of service in communications systems.

### BACKGROUND

Paths through the Internet vary widely in the quality of service they provide. The traditional best-effort model of the Internet does not differentiate between traffic flow that is generated by different hosts. As traffic flow varies, the network provides the best service it can. There are no controls for guarantying a high level of service for some traffic flow and not for others.

Although the Internet itself has no direct controls for optimizing paths for particular applications or users, the Internet Protocol (IP) does provide a header that contains bits for specifying Quality of Service (QoS) information. The value of the QoS information is intended to denote how the network should treat packets of data with regard to throughput, delay, reliability, and cost. QoS information may be conveyed, for example, in layer 2 MAC frame packets as defined in IEEE 802.1p/Q (via the priority field) or in layer 3 IP packets (via the TOS field). The TOS facility, for example, was outlined in Request for Comment (RFC) 791 (“Internet Protocol,” September 1981), authored by the Internet Engineering Task Force (IETF) and available via the Internet at hftp://www.ietf.org. Although the TOS facility has been a part of the IP specification for quite some time, few attempts have been made to utilized it until recently. Recent RFCs from IETF, such as RFC 1633 (“Integrated Services in the Internet Architecture: An Overview”) and RFC 2475 (“An Architecture for Differentiated Services”) are beginning to define how packets should be routed.

With the recent attempts to develop means for providing differentiated QoS, a number of problems have arisen. One such problem is that, for QoS information to be useful, that information must be filled in with reasonable values. While applications have the ability to set the QoS bits for packets that they produce and transmit, they may not utilize this ability. And when they do, they rarely do so in a consistent manner. In other words, one application may give a high priority to video data, while another gives that same priority to email. This inconsistency can significantly limit the ability of communications systems to provide reliable and consistent differentiated quality of service.

### SUMMARY OF THE INVENTION

With the foregoing in mind, methods and systems consistent with the present invention inspect and classify packets of data based on predefined criteria. QoS bits in packets of data are set or reset based on the predefined criteria to provide consistent prioritization criteria for use in further transmission in an associated communications system.

These and other objects, features, and advantages in accordance with the present invention are provided by a method of prioritizing a packet of data transmitted by an application in a data processing system to facilitate transmission and prioritization of said packet in a communications system, which comprises the steps of (a) receiving said packet from said application in said data processing system by a marker; (b) examining said packet for predefined criteria; (c) overriding a value of Quality of Service (QoS) bits in said packet based on said predefined criteria; and (d) forwarding said packet for further transmission based on said value of said QoS bits.

An apparatus is provided for prioritizing a packet of data transmitted by an application in a data processing system to facilitate transmission and prioritization of said packet in a communications system, which comprises (a) means for receiving said packet from said application in said data processing system; (b) means for examining said packet for predefined criteria; (c) means for overriding a value of QoS bits in said packet based on said predefined criteria; and (d) means forwarding said packet for further transmission based on said value of said QoS bits.

A system is also provided for prioritizing a packet of data to facilitate transmission of said packet in a communications system, which comprises (a) a data processing system including a central processing unit and memory containing at least one application; and (b) a marker external from said application for receiving said packet from said at least one application, examining said packet for predefined criteria, overriding Quality of Service (QoS) bits in said packet based on said predefined criteria, and forwarding said packet for further transmission in said communications system based on said QoS bits.

### BRIEF DESCRIPTION OF THE DRAWINGS

FIG. 1 illustrates a conventional communications system.

FIG. 2 illustrates an example of a data processing system illustrated in FIG. 1.

FIG. 3A illustrates an exemplary embodiment of the present invention.

FIG. 3B illustrates the field definitions for IP TOS bits.

FIG. 4A illustrates a second exemplary embodiment of the present invention.

FIG. 4B illustrates a mapping table consistent with the embodiment illustrated in FIG. 4A.

FIG. 5 illustrates a third exemplary embodiment of the present invention.

### DETAILED DESCRIPTION

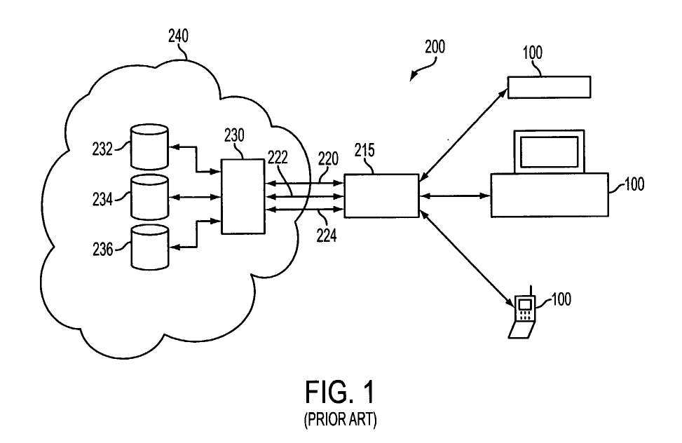

Referring initially to FIG. 1, a description is first made of a conventional communications system in order to facilitate the description of exemplary embodiments of the present invention. FIG. 1 illustrates a conventional communications system 200 that includes one or more data processing systems 100. The communications system 200 also includes a multiple Virtual Circuit (multi-VC) bridge 215 and a number of Permanent Virtual Circuits (PVCs) 220, 222, 224 between the multi-VC bridge 215 and certain network devices 232, 234, 236 located, for example, in a Wide Area Network (WAN) 240. In the communications system 200 illustrated in FIG. 1, the PVCs 220, 222, 224 terminate in a single network device, such as a broadband remote access server (BRAS), typically with a single Media Access Control (MAC) address,. The BRAS is responsible for receiving data from the various PVCs and routing the data to the one or more network devices 232, 234, 236.

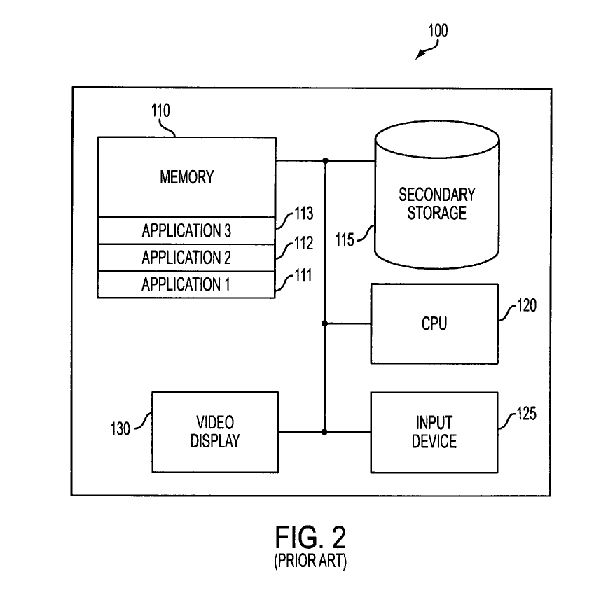

The data processing systems 100 of FIG. 1 may any devices that produce and/or transmit data to the communications system 200 via a physical or wireless communications path. Examples include, but are not limited to, computers, set-top boxes, voice-over-IP phones, etc. FIG. 2 illustrates an example of one of the data processing systems 100 illustrated in FIG. 1. The exemplary data processing system 100 also includes a memory 110, a secondary storage 115, a central processing unit (CPU) 120, an input device 125 (such as a keyboard), and a user interface 130 (such as a video display, LEDs, etc.). The memory 110 contains one or more applications 111, 112, 113 that perform data processing functions and that transmit data to the communications system 200.

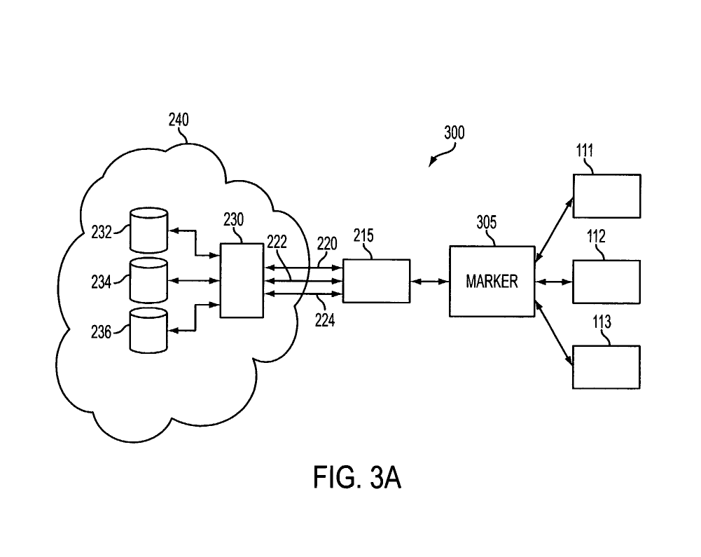

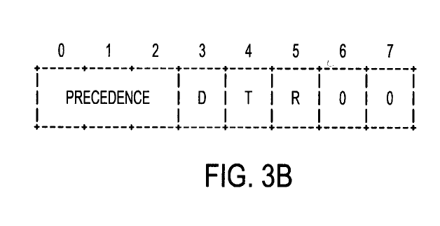

FIG. 3A illustrates an exemplary communications system 300 consistent with the present invention that includes an improved marker 305. The improved marker 305 comprises software and/or hardware for setting and re-setting QoS bits in packets of data transmitted from applications 111, 112, 113, based on predefined criteria.

The Marker

The improved marker 305 inspects packets of data transmitted by the applications 111, 112, 113 and sets or re-sets the QoS bits in those packets. As an example of a QoS facility suitable for use with the present invention, the IP TOS field definitions, as established by RF C791, are listed below and illustrated in FIG. 3C:

Bits 0-2: Precedence.

Bit 3:0=Normal Delay, 1=Low Delay.

Bits 4:0=Normal Throughput, 1=High Throughput.

Bits 5:0=Normal Reliability, 1=High Reliability.

Bits 6-7: Reserved for Future Use.

One problem with conventional communications systems, as discussed above, is that applications do not always set QoS bits in the packets of data that they generate. Even when they do, they often do so without regard to how other applications set QoS bits, causing inconsistency among different applications. To overcome this problem, the improved marker of the present invention takes over the responsibility of setting the TOS bits from the applications. The improved marker differentiates packets of data based on predefined criteria and sets their QoS bits accordingly. The predefined criteria may include, for example, a Point to Point Protocol over Ethernet (PPPoE) session ID, the physical port on which the packet arrived; the source and/or destination IP address of the packet; the well-known Transmission Control Protocol/User Datagram Protocol (TCP/UDP) port numbers for the packet; various layer 7 application information (such as cookies), or a TCP/UDP session associated with a packet.

PPPoE Client Software

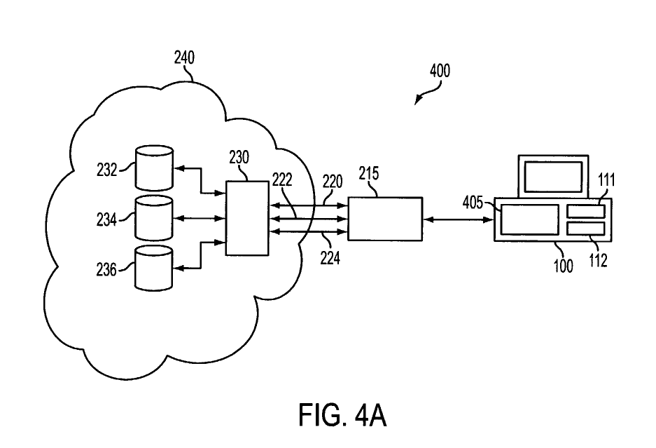

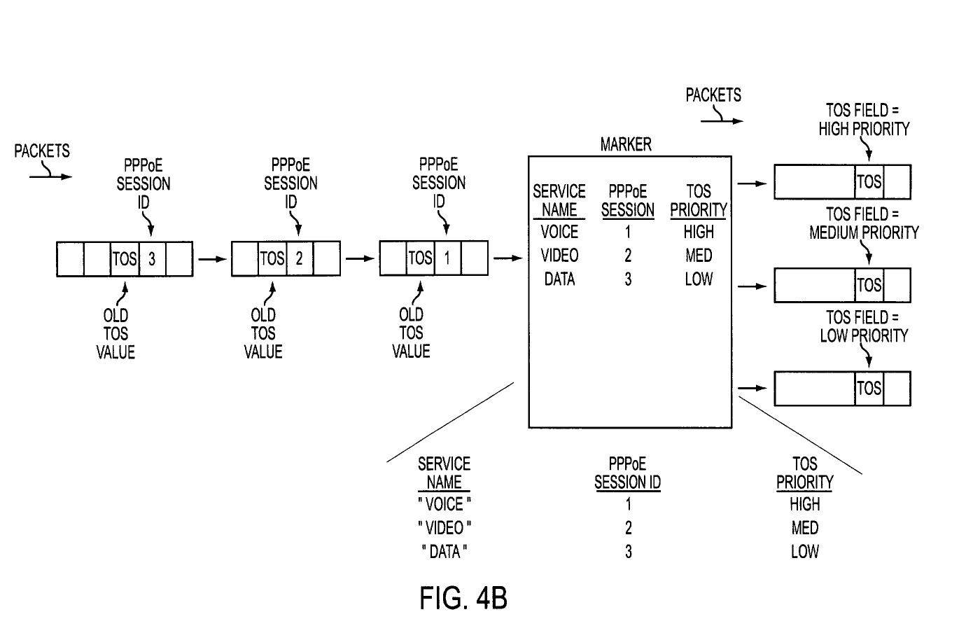

FIG. 4A illustrates an embodiment of the present invention in which the functions of the improved marker are performed by PPPoE client software 405. The PPPoE protocol is defined in RFC 2516. The PPPoE client software 405 may reside, for example, on the data processing system 100. The PPPoE client software 405 sets or re-sets QoS bits of packets by examining the packets for predefined criteria, which in this embodiment is a PPPoE SESSION_ID. The PPPoE client software 405 then cross-references the PPPoE SESSION_ID to a corresponding PVC in a mapping table and marks accordingly. The tracking of SESSION_ID is based on the PPPoE Service-Name association by which the PPPoE session was established. PPPoE sessions allow the PPPoE Service-Name to be used to identify a specific service provider, content server, or quality of service for the session. This embodiment of the invention maintains an association between the Service-Name, PPPoE SESSION_ID, and each QoS value, as illustrated in FIG. 4B.

Router

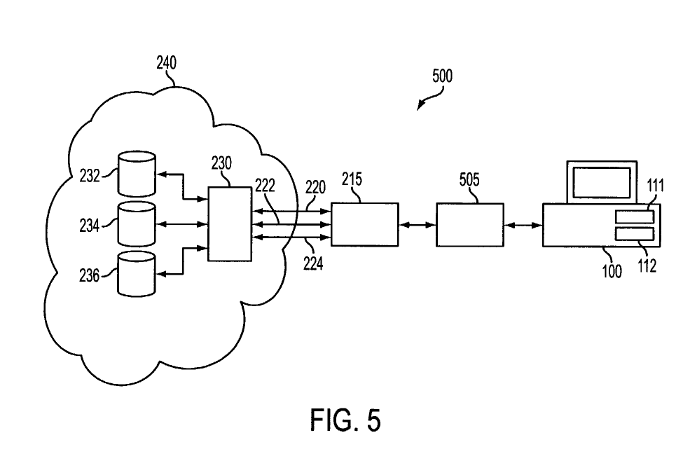

FIG. 5 illustrates an embodiment of the present invention in which the functions of the improved marker are performed by a router or bridge, external to the data processing system 100. In this embodiment, the applications 111 and 112 transmit data packets to the router before they are forwarded on to other network equipment. As with the previous embodiment, the router or bridge examines packets for predefined criteria and sets or re-sets the packet's QoS bits accordingly. In this embodiment, the predefined criteria may be based on the packet's protocol (TCP/UDP), the protocol and the TCP/UDP port number, the physical port number, the IP source and/or destination address, or application data inside the packet. Also, if the marker process includes layer 2 information, it can use MAC source/and or destination address, VLAN tags, or 802.1p priority fields as criteria.

The present invention has been described with reference to the accompanying drawings that illustrate preferred embodiments of the invention. The invention may, however, be embodied in many different forms and should not be construed as limited to the embodiments set forth herein. Rather, these embodiments are provided so that this disclosure will be thorough and complete, and will fully convey the scope of the invention to those skilled in the art. Thus, the scope of the invention should be determined based upon the appended claims and their legal equivalents, rather than the specific embodiments described above.

What is claimed is:

1. A method of prioritizing a packet of data transmitted by an application in a data processing system to facilitate transmission and prioritization of said packet in a communications system, comprising the steps of:
receiving said packet from said application in said data processing system by a marker;
examining said packet for predefined criteria;
overriding a value of Quality of Service (QoS) bits in said packet based on said predefined criteria; and
forwarding said packet for further transmission based on said value of said QoS bits.

2. The method of claim 1 wherein said step of receiving said packet comprises receiving said packet by Point to Point Protocol over Internet (PPPoE) client software.

3. The method of claim 1 wherein said step of receiving said packet comprises receiving said packet by a router external from said data processing system.

4. The method of claim 2 wherein said predefined criteria is a session identification number.

5. The method of claim 3 wherein said predefined criteria is an indication of a physical port from which said packet arrived.

6. The method of claim 3 wherein said predefined criteria is an indication of an Internet Protocol (IP) source or destination address.

7. The method of claim 3 wherein said predefined criteria is an indication of a TCP or UDP port number.

8. The method of claim 3 wherein said predefined criteria is application information at layer 7.

9. The method of claim 3 wherein said predefined criteria is an indication of a TCP or UDP session.

10. An apparatus for prioritizing a packet of data transmitted by an application in a data processing system to facilitate transmission and prioritization of said packet in a communications system, comprising:
means for receiving said packet from said application in said data processing system;
means for examining said packet for predefined criteria;
means for overriding a value of QoS bits in said packet based on said predefined criteria; and
means forwarding said packet for further transmission based on said value of said QoS bits.

11. The apparatus of claim 10 wherein said means for receiving said packet comprises Point to Point Protocol over Internet (PPPoE) client software residing in said data processing system.

12. The apparatus of claim 10 wherein said means for receiving said packet comprises a router external from said data processing system.

13. The apparatus of claim 11 wherein said predefined criteria is a session identification number.

14. The apparatus of claim 12 wherein said predefined criteria is an indication of a physical port from which said packet arrived.

15. The apparatus of claim 12 wherein said predefined criteria is an indication of an Internet Protocol (IP) source or destination address.

16. The apparatus of claim 12 wherein said predefined criteria is an indication of a TCP or UDP port number.

17. The apparatus of claim 12 wherein said predefined criteria is application information at layer 7.

18. The apparatus of claim 12 wherein said predefined criteria is an indication of a TCP or UDP session.

19. A system for prioritizing a packet of data to facilitate transmission of said packet in a communications system, comprising:
a data processing system including a central processing unit and memory containing at least one application; and
a marker external from said application for receiving said packet from said at least one application, examining said packet for predefined criteria, overriding Quality of Service (QoS) bits in said packet based on said predefined criteria, and forwarding said packet for further transmission in said communications system based on said QoS bits.

20. The system of claim 19 wherein said marker comprises Point to Point Protocol over Internet (PPPoE) client software residing in said data processing system.

21. The system of claim 19 wherein said marker comprises a router external from said data processing system.

22. The system of claim 20 wherein said predefined criteria is a session identification number.

23. The system of claim 21 wherein said predefined criteria is an indication of a physical port from which said packet arrived.

24. The system of claim 21 wherein said predefined criteria is an indication of an Internet Protocol (IP) source or destination address.

25. The system of claim 21 wherein said predefined criteria is an indication of a TCP or UDP port number.

26. The system of claim 21 wherein said predefined criteria is application information at layer 7.

27. The system of claim 21 wherein said predefined criteria is an indication of a TCP or UDP session.
